(19) United States
(12) Patent Application Publication
(10) Pub. No.: US 2010/0005115 A1
(43) Pub. Date: Jan. 7, 2010

(54) METHOD AND SYSTEM FOR GENERATING DOCUMENTS USABLE BY A PLURALITY OF DIFFERING COMPUTER APPLICATIONS

(75) Inventors: Sven Richter, Nalldorf (DE); Marcel Kieser, Buietal (DE); Rudolf Zens, Wiesbaden (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 12/167,787

(22) Filed: Jul. 3, 2008

(51) Int. Cl. G06F 7/00; G06F 17/00

(52) U.S. Cl. 707/101; 707/E17.006

(57) ABSTRACT

Embodiments of the present invention provide a system, computer-readable medium and a method for maintaining data in a format usable by a plurality of different computer applications. Data is input into a first application document having a first format and received by the system. The data is parsed from the first application document, and the parsed data is converted to a raw data string. A template associated with the raw data string is selected in a second computer application. Based on information related to the association of the template to the raw data string, the raw data string is converted to a second application document having a second format. The second application document is presented on an output device or stored in the second document format.

### BACKGROUND

The ability to quickly and efficiently generate documents that allow documents to be shared among a plurality of differing computer applications is presently unavailable in the present computing environment. The presently available methods do not appear to provide a capability to generate documents from a template of a first computer application and share the data within the document of a second computer application. Accordingly, there is a need to provide a method and system for generating documents from a template that are usable by a plurality of differing computer applications.

Today businesses utilize a number of documents for tracking business processes, and simply conducting business. Often, documents are generated based on existing document templates, however, for various reasons, such as including the embedded metadata, the templates do not allow the documents created with the template to be shared among differing business computer applications, such as SAP Netweaver and Microsoft Excel.

For example, in the past, the user might select a template, if a template was even available, in application Z, for example, and attempt to access data that was input via a template in application W, for example. If the data was compatible meaning that the data fields matched from the template of application Z to the data fields of application W, the user would be presented with the data. However, if the user chose a template in application Z that had data fields that were incompatible with the data fields of the template in application W, in some cases, e.g., extreme cases, the application Z would terminate due to the incompatibilities of the data with the format of application W.

Attempts have been made to create a document template suitable for such a purpose. For example, one attempt created a generic template that is then modified by data stored in a delta file. However, this was limited to having to be used with the same computer application.

Another attempt provided a layout file of an HTML document including instructions that have parameterized values for altering the layout based on the parameter values.

Another attempt apparently involved a document template and a configuration template. The configuration template described the class of data to be included in the document and the document template defined how instances of the data were to be displayed to a user.

None of the above attempts provided for a document template that packages data in a format capable of being used across a plurality of differing computer applications. Accordingly, there is a need for a document template that packages data in a format that is presentable and accessible by a plurality of differing computer applications.

### BRIEF DESCRIPTION OF THE DRAWINGS

FIG. 1 illustrates an exemplary flowchart of a method according to an embodiment of the present invention.

FIG. 2 illustrates an exemplary flow of the template generation and handling according to an embodiment of the present invention.

FIG. 3 illustrates an exemplary flow of the data conversion according to an embodiment of the present invention.

FIG. 4A illustrates an example of a template header for a raw data string bitstream and an exemplary attribute fields and data in the raw data string bitstream according to an exemplary embodiment of the present invention.

FIG. 4B illustrates an example of a template header for a raw data string bitstream and an exemplary attribute fields and data in the raw data string bitstream according to an exemplary embodiment of the present invention.

FIG. 5 illustrates an exemplary system for implementing the disclosed methods according to an embodiment of the present invention.

### DETAILED DESCRIPTION

An embodiment of the present invention provides a computer-implemented method for maintaining data in a format usable by a plurality of different computer applications. Data is input into a first application document having a first format via a document template and received by the system. The data is parsed from the first application document, and the parsed data is converted to a raw data string. In response to selection of a template in a second application, the raw data string is converted to a second application document having a second format according to the selected template. The second application document is presented to a user or stored in the second document format.

An embodiment of the present invention provides a computer readable medium embodied with instructions for a method for maintaining data in a format usable by a plurality of different computer applications. The instructions cause a computer execute a method including receiving data that is input into a first application document having a first format via a document template. The data is parsed from the first application document, and the parsed data is converted to a raw data string. In response to selection of a template in a second application, the raw data string is converted to a second application document having a second format according to the selected template. The second application document is presented to the user or stored in the second document format that is a logical presentation of the data, or in some other form.

An embodiment of the present invention provides a system for maintaining, presenting and manipulating data by a plurality of different computer applications. The system includes a display device for displaying a graphical user interface and data in the plurality of different computer applications, a data storage for maintaining data; and a processor connected to the display device and configured to receive inputs from the graphical user interface to manipulate and present data. The processor is configured to execute the functions of receiving data that is input into a first application document having a first format via a document template. The data is parsed from the first application document, and the parsed data is converted to a raw data string. In response to selection of a template in a second application, the raw data string is converted to a second application document having a second format according to the selected template. The second application document is presented to the user in the second document format that is a logical presentation of the data.

Templates are a data framework that allows users to easily create new documents by using predetermined data configurations. In some situations, systems allow two different type of document inputs: a user specific template, and master templates that are valid for all users. User specific templates are preferably only accessible for the user who created the template data. Although an administrator can copy the user and by using this mechanism the templates were copied as well. Companies can also define templates that are accessible by a specified group of users that allows them to control the access to these templates by users in the specific group.

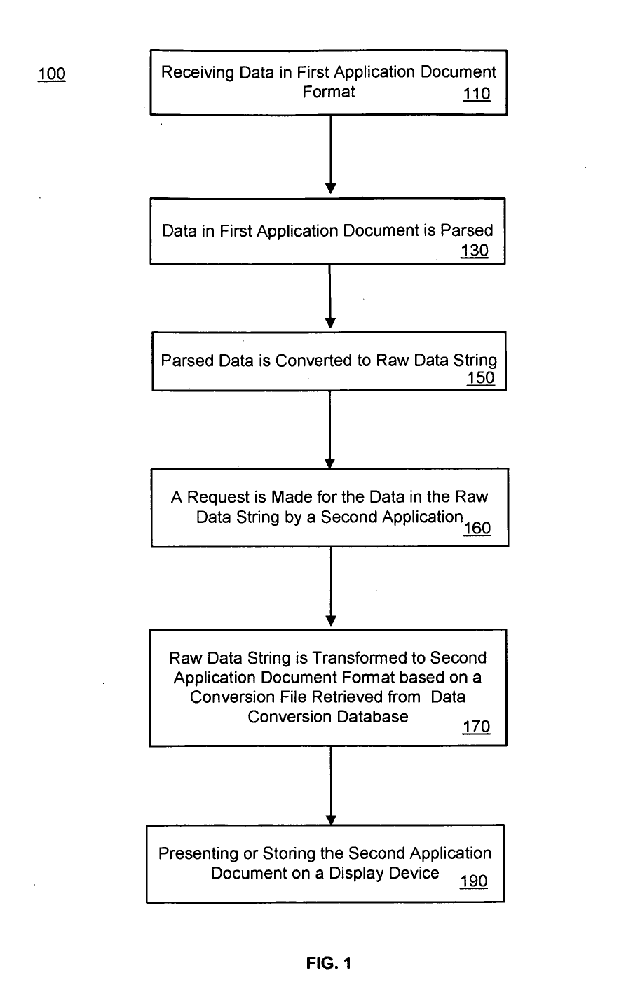

FIG. 1 illustrates an exemplary flowchart of a method according to an embodiment of the present invention. The exemplary method will be described in more detail with reference to FIG. 1. The exemplary process 100 for maintaining data in a format usable by a plurality of different computer applications receives a document comprising data in a first application data format at step 110. The first application document can be a template that was filled in by a user. Document templates can include information that indicates data format, and other document parameters. The template can include data imported automatically by the first document application or include data input by a user or a combination of both. The template can include data that does not change frequently, such as a corporation name, corporation address, user name and the like. When the user has completed filling in the template document or when the template document is being saved, the data in the template document is parsed at step 130. Not all of the data in the template needs to be parsed, such as the data that does not change frequently. This data can be incorporated by the individual applications, for example. Basically, the data parsed is stripped to the minimum necessary data.

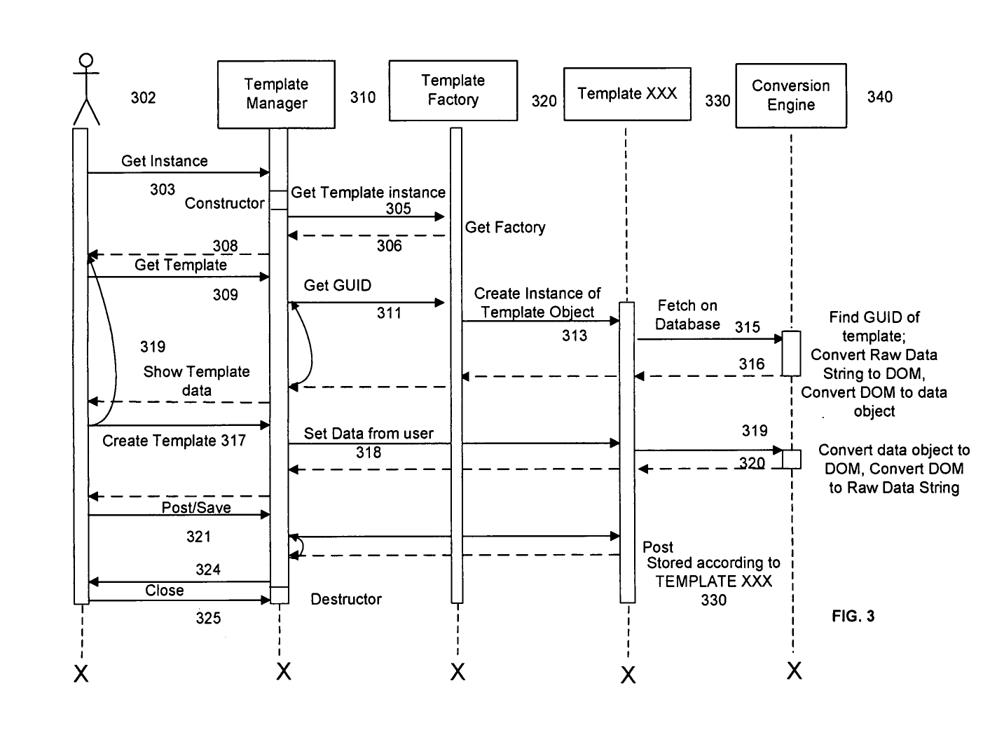

Parsing can be performed by a conversion engine and includes removing data field values from the template and other data associated with the document template using techniques known in the computer arts. In step 150, the parsed data is converted to a raw data string. Conversion engines in a conversion utility are capable of converting data of differing formats into an XML or other format are known in the computer arts. The exemplary conversion can include a number of steps, such as conversion to a number of intermediate formats before the data is in a final raw data string format. The raw data string, such as a binary large object, can have a number of attributes that suitable for storage in a predefined data structure, or database schema, of a database. An exemplary conversion will be described in more detail with reference to FIG. 3.

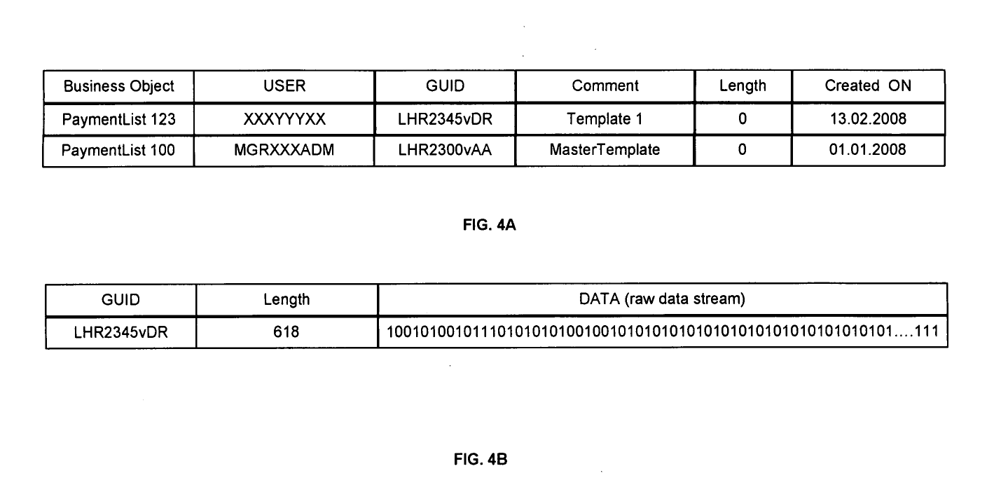

The raw data string can be stored for future use by another user or the same user. However, for a number of reasons, the data may be needed by a user that does not have access to the first computer application. The raw data string is stored in a raw data bitstream. The bitstream will include attributes, such as information for identifying the bitstream and associating the bitstream data with a particular template. The bitstream will be described in more detail with respect to FIGS. 4A and 4B. The information for identifying the raw data bitstream can include a name provided by the user, an identifier or some other form of identifying information, and association attributes can include a parent business object, data length and the like. In step 160, a request is made for the data in the raw data string by a second application. For example, a user may desire to view the data in a particular application, which happens to be a second application having data presented in a different template format than the template format in which the data was initially saved. The user, in the example, can be presented with a list of templates associated with both the second application and the raw data. This is done by using the attributes stored in the raw data bitstream such as a global unique identifier (GUID), a name provided by a user, or the name of the business object associated with the template, such as invoice or payment, to locate templates capable of presenting the data. The business object can be a representation of an identifiable business entity such as a customer, a sales order, invoice, payment or a product that is defined once and becomes a building block of the business. It can preferably be described by a data model, an internal process model and one or more service interfaces.

By associating the template to the GUID or business object, the point of reference for the data is raised to a business use level above the particular computer applications used to operate on the data. This makes the data generic to the enterprise, so the templates need only be associated with the business operations of the enterprise and the data can be imported into the appropriate templates in each of the different computer applications that may be used within an enterprise.

Continuing in step 160, the user selects a template and the system continues to process the request by retrieving the raw data string. The calling instance will know which template was selected by the user will be capable of presenting the data in an acceptable format based on the GUID and or other identifying information associated with the data in a template header or data string bitstream.

At step 170, the raw data string is transformed to a second document format based on a conversion file suitable for the selected template retrieved from a database, such as a data conversion data base or by a software utility, such as a conversion engine, for example, a conversion agent provided by a software system, and attribute data included with the raw data string, such as a GUID, a data length, name of data structure storing the raw data and/or the business object associated with the template used to create the raw data string. The data length can be determined based on the pattern of the parsed data by referencing, or comparing, data patterns stored in a conversion engine, or XML library. The data conversion database can be a data storage for storing a plurality of data templates from a plurality of different computer applications. For example, the data conversion database can be an XML library that can be used in combination with a conversion engine to place the raw data string into data having an XML format. This XML formatted data is of a form that allows the plurality of different computer applications using the appropriate templates to access the data, store, manipulate and present the data on an output device, such as a display device or printer, or store the data in a database or other storage device (step 190). Accordingly, a second user does not need to have the same computer application as a first user to review, retrieve or receive data input via a first document template.

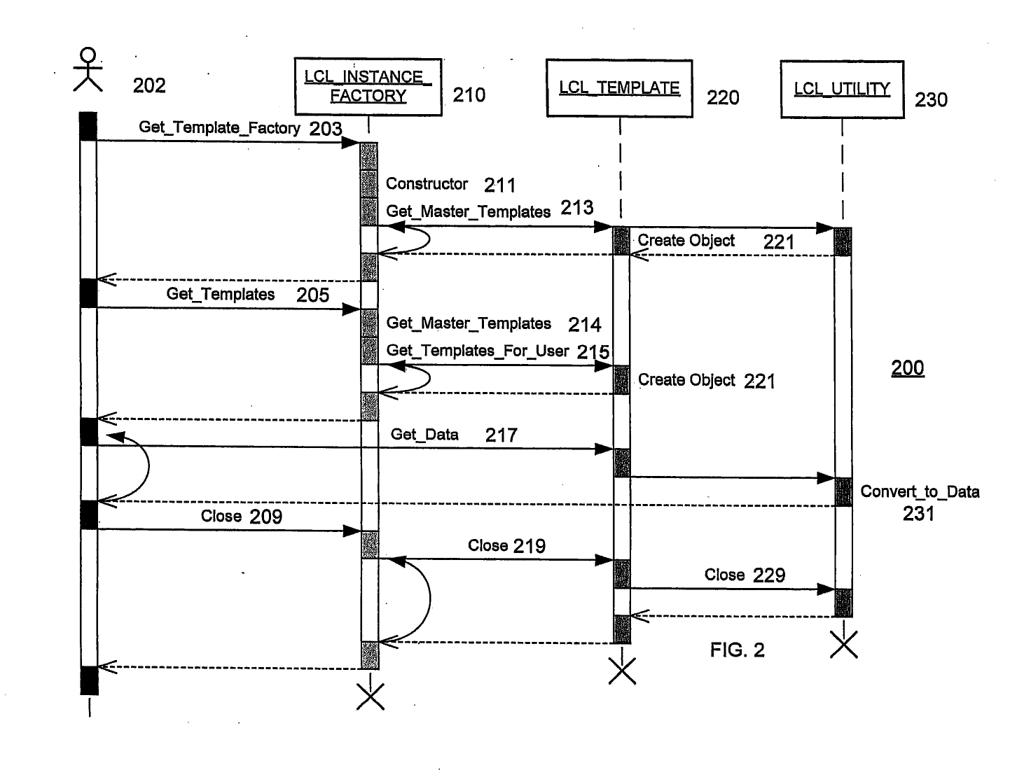

FIG. 2 illustrates an exemplary flow of the document data generation and handling according to an embodiment of the present invention. The exemplary method 200 illustrated in FIG. 2 comprises a user requesting a template for use by a user client 202. A routine 203, such as a Get_Template_Factory routine, can be called when a user 102 requests access to templates. Using a user ID provided by the user client 202 or retrieving from another source data other identifying or associated with the user client 202, master templates as well as user specific templates can be provided to the user client 202. Upon execution of routine 203, a software module, for example, local class instance factory 210 is called. The local class instance factory 210 can be, for example, a template factory that controls each of the templates. A template factory can be a routine that generates templates for a business and maintains control over the templates. Each business object can have a relevant template. Upon authorization of the user client 202, a routine, such as constructor 211, can be instantiated as a private instance and will set an imported business object in the users attributes. After completing authorization of the user client 202, a routine, such as, for example, Get_Master_Templates, 213 is called. The exemplary Get_Master_Templates 213 routine identifies general templates available for all users. The general templates can be grouped by business objects. This allows a user to work on templates within the business objects that the user is presently working, e.g., purchase orders and the like. This minimizes the number of templates that are presented to a user and that may not be relevant to the user's present working environment.

Each of the templates can have an administrator feature that allows the creation of templates from a present user to be recreated for a new user. Each template, both master templates and user-specific templates, will be associated with a business object, such as Invoice, Payment, Shipping and the like. This facilitates the user in determining the types of data that can be input into the template. The new user will have complete control of the newly-created templates that are associated with a business object and can create new templates of their own without affecting the templates of the previous user. The exemplary Get_Master_Templates 213 routine returns a list of all the master templates available for the current business object. Upon retrieving the list of templates, a user selects a template and a routine 220, such as, for example, the local class LCL_Template, is called. The LCL_Template 220 routine is responsible for handling all data for a specific template selected by a user client 202. Upon creating a template object 221, a routine such as, for example, the local class utility (LCL_Utility) 230 is obtained by the constructor 211. The instance of the constructor 211 selects template data from a table and sets the template object 221 to be persistent. The template object 221 can be assigned a unique identifier, such as, for example, a global unit identifier (GUID).

Once the instance of the local utility 230 is available to the user client 202, the user client 202 can execute an exemplary routine 205, such as a Get;_Templates routine, by requesting a template via a user input control on a graphical user interface or some other input interface. The templates are obtained from a data store by a routine 214, which can be, for example, the Get_Master_Templates. If the user client 202 desires to create their own template, a routine for this purpose can be called, for example, the Get_Templates_For_User routine 215. A template object 221 is created and returned to the user client 202. User client 202 identifies data that the user would like to incorporate into the template. The routine 217, such as, for example, Get_Data routine, can be called to extract or parse data, including user-identified data, from an identified document. The routine can access an XML library and use a conversion engine to provide a well-known data formatting utility.

The exemplary Get_Data routine 217 is a routine that converts the user-identified data into an XML data string. The XML data string has a format that allows it to be easily translated into a plurality of different computer applications. By making the XML data string generic by removing template metadata and the like, the exemplary Get_Data routine 217 can populate a plurality of different computer application data presentations with minimal information provided by the user, and submits the extracted user-identified data to a local class utility 230. The local class utility 230 calls a routine 231, such as an exemplary Convert_To_Data routine. Routine 231 can convert the extracted user-identified data to an XML data string that is incorporated into the template. The XML data string is stored in a data store for subsequent editing and reuse.

The process returns to the user client 202, which closes the templates via processes 209, 219 and 229. In addition, the local instance factory 210, the instance of the local class 220 and the local class utility 230 are closed. The process is completed.

The exemplary Convert_To_Data 231 routine will be explained in more detail with reference to the exemplary embodiments illustrated in FIG. 3. The exemplary Convert_To_Data 231 can involve input from the user client 302 and instances of routine 310, such as, for example, Class Template Manager, routine 320, such as, for example, a local class of Template Factory, routine 330, such as, for example, a local class Template XXX, and routine 340, such as, for example, an XML Library. The exemplary local class Template XXX 330 can be the local class for a number of templates, such as Sales Area Data and Document Builder. The exemplary templates can include metadata indicating formatting and other document parameters or attributes.

The exemplary XML Library 340 can be used to create a generic solution for handling templates, the data is preferably stored in a generic format. This can be leveraged by some companies that have a pre-existing XML library because the pre-existing XML library can be re-used. The XML files are preferably not stored directly in a data dictionary object due to a number of reasons, such as data size limitations. The XML file is preferably converted into a binary large object (BLOB) before it is stored in a data dictionary object. The binary large objects can be assigned a generic identifier such as a globally unique identifier (GUID), and the GUID can be assigned to a template name.

The exemplary method is initiated by a user client 302 requesting, at step 303, an instance of the template manager 310 via an exemplary routine, such as, for example, Get_instance. An exemplary routine, such as a Get_Template_Instance, can be called, at step 305, and forwards a request for an exemplary Get_Factory routine from the exemplary Template Factory 320. At step 306, the exemplary Template Factory 320 returns the interface from the exemplary Get_Factory routine to the exemplary Template Manager 310, that forwards the interface to the user client 302 at step 308 thereby providing the exemplary user client 302 with a mechanism to choose a template from a list of templates.

At step 309, a template is selected based on an input into the interface on the user client 302, any pre-existing data in the selected template, such as pre-existing corporate name and address information and the like, is obtained in the following steps 311-316. The exemplary Template Manager 310 obtains a Global Unique Identifier (GUID) via a Get_GUID routine, at step 311, from the exemplary Template Factory 320. The Template Factory 320 routine has access to a database that tracks and generates all template GUIDs. The Template Factory 320 forwards, at step 313, an instance of the template via the exemplary routine, such as a Create_Template routine, to the Template XXX 330. The instance of utility Template XXX 330 is determined by the GUID provided by the Template Factory 320. At step 315, the Template XXX 330 makes a call, or fetch request to the XML Library 340. The XML library 340 provides the XML data files for converting any of the pre-existing template data into a format suitable for a template chosen according to the GUID provided by the Template XXX 330. The Template XXX 330 can receive the pre-existing template data via step 316, the data can subsequently be forwarded to the user client 302.

In step 315, the XML conversion file retrieved from XML Library 340 can be used to access the raw data string, such as a binary large object, or a BLOB. The BLOB is preferably a data string that is part of a predefined structure suitable for storage in a database, and can include attributes for the GUID, length of the data string, an identifier of the business object associated with the template from which data is parsed, and the parsed data (or a coded or compressed representation thereof). The raw data string can be converted to an intermediate format, a DOM, which is then converted to a data object for insertion into the template. Following step 316, the user client 302 is presented with templates filled in with pre-existing data that are associated with the GUID. In other words, the data in the BLOB can be imported into the template associated with the GUID, and be presented on the user client 302 in a proper format with no or minimal errors. The user client 302 receives an input selecting one of the presented templates for presentation of the data.

The BLOB can be further converted to an intermediate form. For example, in an SAP-based implementation, a document standard data structure called a document object model (DOM) can be used. A DOM can be used to model documents with a specific business object, e.g., invoices or sales orders, thereby providing uniformity within the business object. However, a DOM requires a large amount of memory when stored; therefore, it is preferred not to store the DOM. The DOM can be formed and converted to a minimum amount of data, a data object, suitable to represent the document created from the template by the user client 302. It is this data object that can generically represent the template to other applications. The data object will be incorporated into a template for presentation to the user. The data representing the document data in the template is returned at step 316 to the user client 302. The template data is presented on the user client 302 to a user. The user via the user client 302 inputs, deletes, confirms, revises or otherwise manipulates the data in the template, i.e., Set_Data, routine at step 317, which is returned to the local class Template XXX 330 for conversion of the data structure formed by the Set_Data to the data format of the template. At step 318, the user client 302 creates the document using the template, which can comprise incorporating data into the template data input fields and other information. After receiving input from a user in which work has been completed or partially completed on the template by the user client 302, the completed or partially completed template is transferred for conversion by the XML Library 340, for example, to an intermediate format, if necessary for purposes of data storage. In the case of an SAP or other legacy system implementation, for example, the data is converted to an intermediate form of a DOM. The intermediate form, or DOM, if in a SAP, or other legacy system, implementation, is converted to a raw data string, or BLOB. The data is returned to the user client 302 for posting in step 320. The user client 302 posts the data at step 321, and, at subsequent step 322, the data is posted to a database according to instructions by the Template XXX 330 utility. The user client 302 can close the session at step 325, in which case, a destructor utility destroys the computer objects created during the process and frees any memory that was allocated during the above described process.

The exemplary embodiment described with reference to FIGS. 2 and 3 is only exemplary for the sake of understanding and should not be used to limit the scope of the exemplary embodiments.

FIGS. 4A and 4B illustrate an example of a template header for a raw data string bitstream and an exemplary attribute fields and data in the raw data string bitstream according to an exemplary embodiment of the present invention. The raw data string bitstream can comprise a template header bitstring and the data bit string.

At the database level, FIG. 4A presents a template header that can include a business object identifier, a user identifier, a GUID of the template, a created-on date, and a comment. This administrative data is used to provide in the template information that is separated from the operational data shown in FIG. 4B. This aids in performance of the process by not requiring the separation of the administrative data from the operational data in the same bitstream.

FIG. 4B illustrates the data bitstream including the raw data string. This is the data bitstream can include a GUID, length of data, and the raw data that was parsed from the document template. The conversion engine operates with the bitstream shown in FIG. 4B. The conversion engine will use the information in the data bitstream in combination with the administrative header information shown in FIG. 4A to convert the raw data into an XML format as explained above with reference to FIGS. 1-3. Of course, the exemplary illustrations of the data structure in FIGS. 4A and 4B are only examples, and it is understood that other data implementations are suitable for purposes of implementing the exemplary embodiments. For example, the bitstreams of FIGS. 4A and 4B can be combined into a single bitstream, but for purposes of enhancing system performance are implemented as separate bitstreams.

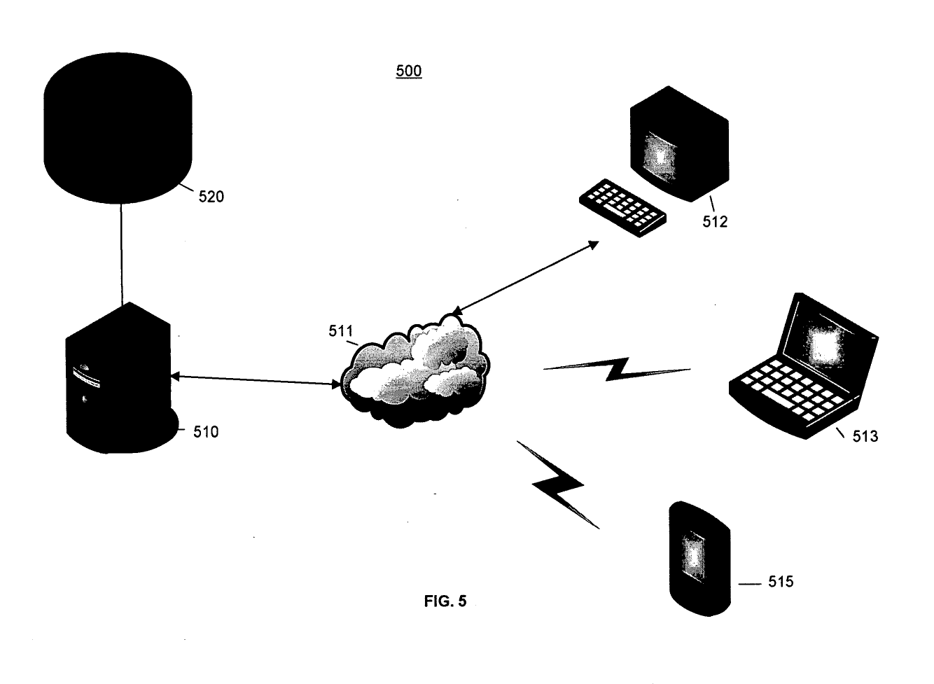

FIG. 5 illustrates an exemplary system for generating and retrieving a generic template usable by a plurality of different computer data applications. The exemplary system 500 comprises a server 510, network 511, client terminals 512, client laptops 513, client handhelds 515 and data repository 520.

The server 510 comprises a processor and can host a plurality of software modules accessible by client terminals 512, client laptops 513, or client handhelds 515 through the network 511. Each of the client terminals 512, client laptops 513, or client handhelds 515 can have installed a plurality of different data processing and other types of computer applications that use data overlapping from one of the different data processing or computer applications to another of the data processing or computer applications. The software modules can be operated on the server 510 thereby using the processing power available to the server 510. Alternatively, the plurality of software modules, or portions of, can be downloaded to devices 512, 513 or 515. The plurality of software modules can include a first module for receiving data in the first application document format from one of devices 512, 513, or 515. A second module can parse the data from the first application document format, can convert the data to a raw data string or into an intermediate form, and send the data for storage in data storage 520. A third module can perform the function of retrieving the data from data storage 520 and transforming the data to a second application document having a second data format that is different from the format of the first application document. Data storage 520 can be a relational database, and stores the data obtained and generated by the second module, the third module and the fourth module.

Each of devices 512, 513 and 515 can comprise a processor and a display device, and be capable of receiving inputs from a graphical user interface. In addition, devices 512, 513 and 515 can be used to generate data and templates usable in the disclosed method.

Network 511 can be the Internet, an intranet, a public network, a private network, a local area network (LAN), a wide area network (WAN), a wireless network, or any network suitable for implementing the exemplary embodiments.

The software modules including program instructions can be stored on computer readable media such as discs, including CD and DVD, flash memory, hard drives including magnetic and optical drives, or any other suitable computer readable media, and that will cause a computer or processor to execute the program instructions. The software language used to write the software modules can be any that is suitable for implementing the described exemplary embodiments, and such languages are known to those of skill in the art.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A computer-implemented method for maintaining data in a format usable by a plurality of different computer applications, comprising:
receiving a first application document in which data input into the document has a first format and is input via a document template;
parsing the data from the first application document;
converting the parsed data to a raw data string;
in response to selection of a template in a second application, converting the raw data string to a second application document having a second format according to the selected template; and
presenting or storing the second application document.

2. The computer-implemented method of claim 1, the receiving further comprising
instantiating a template factory utility that controls templates of the first application and generates a user graphical interface for allowing a user to input data into a template of the first application document.

3. The computer-implemented method of claim 1, the parsing further comprising:
instantiating a computer routine that parses data from data input fields of the first application document generated by a user from a document template.

4. The computer-implemented method of claim 1, the converting further comprising:
converting the parsed data into an intermediate form prior to converting the data into a raw data string.

5. The computer-implemented method of claim 1, the transforming further comprising:
accessing the data to be transformed;
converting the data to be transformed to an intermediate form;
accessing conversion engine; and
transforming the data in the intermediate form by accessing a conversion file associated with the intermediate form into the raw data string.

6. The computer-implemented method of claim 5, wherein the raw data string is a binary large object.

7. The computer-implemented method of claim 1, wherein the second format is different from the first format.

8. The computer-implemented method of claim 1, wherein the conversion file is retrieved from a data conversion library.

9. The computer-implemented method of claim 1, the converting step further comprising:
receiving a data structure for storing data in a database;
using the parsed data, determining a data length;
storing an name value of the data structure, a global unique identifier, the determined data length, and a value of a business object associated with the document template in the database.

10. A computer readable medium embodied with instructions for a method for maintaining data in a format usable by a plurality of different computer applications, the instructions causing a computer to execute the method, comprising:
receiving a first application document in which data input into the document has a first format and is input via a document template;
parsing the data from the first application document;
converting the parsed data to a raw data string;
in response to selection of a template in a second application, converting the raw data string to a second application document having a second format according to the selected template; and
presenting or storing the second application document.

11. The computer readable medium of claim 10, the receiving further comprising:
instantiating a template factory utility that controls templates of the first application and generates a user graphical interface for allowing a user to input data into a template of the first application document.

12 The computer readable medium of claim 10, the parsing further comprising:
instantiating a computer routine that parses data from data input fields of the first application document generated by a user from a document template.

13. The computer readable medium of claim 10, the converting further comprising:
converting the parsed data into an intermediate form prior to converting the data into a raw data string.

14. The computer readable medium of claim 10, the transforming further comprising:
accessing the data to be transformed;
converting the data to be transformed to an intermediate form;
accessing conversion engine; and
transforming the data in the intermediate form by accessing a conversion file associated with the intermediate form into the raw data string.

15. The computer readable medium of claim 14, wherein the raw data string is a binary large object.

16. The computer readable medium of claim 10, wherein the second format is different from the first format.

17. The computer readable medium of claim 10, wherein the conversion file is retrieved from a data conversion library.

18. The computer readable medium of claim 10, the converting further comprising:
receiving a data structure for storing data in a database;
using the parsed data, determining a data length;
storing an absolute name value of the data structure, a global unique identifier, the determined data length, and a value of the business object associated with document template.

19. A system for maintaining, presenting and manipulating data by a plurality of different computer applications, comprising:
a display device for displaying a graphical user interface and data in the plurality of different computer applications;
a data storage for maintaining data; and
a processor connected to the display device and configured to receive inputs from the graphical user interface to manipulate and present data, the processor configured to perform:
receive a first application document in which data input into the document has a first format and is input via a document template;
parse the data from the first application document;
convert the parsed data to a raw data string;
In response to selection of a template in a second application, converting the raw data string to a second application document having a second format according to the selected template; and
present or store the second application document.

18. The system of claim 19, the receiving further comprising:
instantiating a template factory utility that controls templates of the first application and generates a user graphical interface for allowing a user to input data into a template of the first application document.

19. The system of claim 19, the parsing further comprising:
instantiating a computer routine that parses data from data input fields of the first application document generated by a user from a document template.

20. The system of claim 19, the converting further comprising:
converting the parsed data into an intermediate form prior to converting the data into a raw data string.

21. The system of claim 19, the transforming further comprising:
accessing the data to be transformed;
converting the data to be transformed to an intermediate form;
accessing a conversion engine; and
transforming the data in the intermediate form by accessing a conversion file associated with the intermediate form into the raw data string.

22. The system of claim 19, wherein the raw data string is a binary large object.

23. The system of claim 19, wherein the second format is different from the first format.

24. The system of claim 19, wherein the conversion filter is retrieved from a data conversion library.

25. The system of claim 19, the converting further comprising:
receiving a data structure for storing data in a database;
using the parsed data, determining a data length;
storing an absolute name value of the data structure a global unique identifier, the determined data length, and a value of the business object associated with document template.
